(19) United States
(12) Patent Application Publication
(10) Pub. No.: US 2025/0191556 A1
(43) Pub. Date: Jun. 12, 2025

(54) Guitar Beanie

(71) Applicant: Shedrach Rowry, Hutto, TX (US)

(72) Inventor: Shedrach Rowry, Hutto, TX (US)

(21) Appl. No.: 18/534,573

(22) Filed: Dec. 9, 2023

(51) Int. Cl. G10D 3/14

(52) U.S. Cl. CPC G10D 3/14

(57) ABSTRACT

A novel form of guitar's headstock sleeve that fits over the tuning pegs is disclosed. The assembly is developed from high quality fabric, comes in variety of colors and designs, is easy to install and comes with a back tie-lace up, a zipper, and/or Velcro, with openings for the tuning pegs to stick out. The assembly maintains its outlook and effectiveness over longer period of time.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to sound instruments and more particularly to a guitar headstock sleeve that fits over the tuning pegs.

### Description of the Related Art

Owners of musical instruments have long struggled with the issue of protecting their valuable instruments from damage. For example, instruments are often shaped to have numerous exposed edges, many of which may sustain various dings, dents and chips from accidental contact with objects during use or when the instrument is simply set down, leaned against a wall or other object, or otherwise disposed of when not being played. With today's instruments being increasingly expensive, and some being actual investments, there is a need to protect the original shape and finish against damage generally associated with normal use.

Because of the near proclivity of hand-held instruments to attract the foregoing normal-use damage when not being played, manufacturers and after-market retailers have designed a large number of differing cases, wall-holding and instrument stand devices capable of supporting the various instrument components. These stand devices range from the mechanically simple to extraordinarily complex, with each design being an attempt to provide short or long term damage free storage during nonuse. While these devices are valuable tools used to protect instruments from damage, they are not always available, convenient or easily transported or useable during normal use and short term storage or non-use of an instrument. Thus, the problem of damage to valuable instruments remains. Moreover, this risk is virtually constant and continuous, especially when instruments include materials that are easily damaged by inadvertent contact with floors, furniture, equipment or the like.

Thus, it is likely that a musical instrument user will often find themselves desiring to set down their instrument, even if only momentarily, and not find a conveniently appropriate stand or other protective device capable of reducing wear caused by normal use.

A search of the prior art did not disclose any patents that read directly on the claims of the instant invention; however, the following references were considered related.
U.S. Pat. No. 6,054,642, issued in the name of Brooks;
U.S. Pat. No. 5,725,094, issued in the name of Moral;
U.S. Pat. No. 7,453,034 B2, issued in the name of Johnson;
U.S. Pat. No. D315,167, issued in the name of Willis;
U.S. Pat. No. D285,700, issued in the name of White;
U.S. Pat. No. 7,462,769 B2, issued in the name of Kilpatrick;
U.S. Pat. No. 4,000,678, issued in the name of Messina;
U.S. Pat. No. D278,442, issued in the name of Whomsley;
U.S. Pat. No. D320,405, issued in the name of Wyant; and
U.S. Pat. No. 4,177,847, issued in the name of Spindler.

There are multiple solutions that have been presented in prior art. However, these solutions are limited and restricted to their conventional systems. The current invention is focused on presenting an assembly which is directed toward most advanced and flexible Guitar headstock sleeve that can be a slip-on cover with a back tie-lace up cover, a zipper, and/or Velcro, with openings for the tuning pegs to stick out.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of an interchangeable decorative covers for guitar headstock.

It is also the primary objective of the invention to provide a lightweight, portable, collapsible, and foldable, protective cover for a guitar headstock.

It is another objective of the invention to provide a main assembly developed from high quality fabric and comes in variety of colors and designs to satisfy every individual's unique needs.

It is further the object of the invention to provide a protective cover for a guitar comprising a flexible, stretchable, and returnably-resilient body adapted to form fit to the contours of the headstock of the guitar.

It is also the object of the invention to provide a back tie lace up adapted to aid in securely holding the protective cover onto the headstock of the guitar.

It is further the object of invention to provide an assembly which is susceptible of a low cost of manufacture with regard to both materials and labor, and which accordingly is then susceptible of low prices of sale to the consuming public, thereby making such cleaning assembly economically available to the buying public.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 discloses the complete view of assembly as per preferred embodiments of the invention.

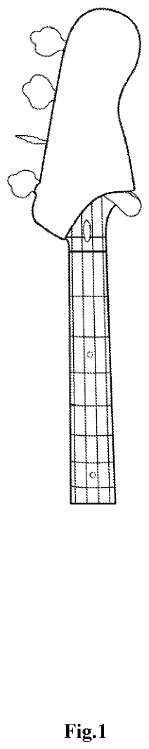

FIG. 2 discloses the side view of assembly as per preferred embodiments of the invention.

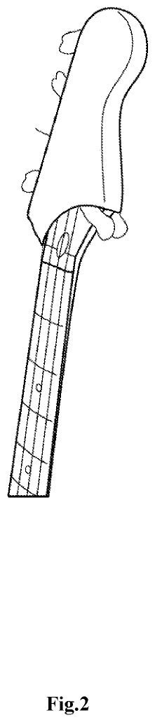

FIG. 3 discloses the complete view of assembly as per preferred embodiments of the invention.

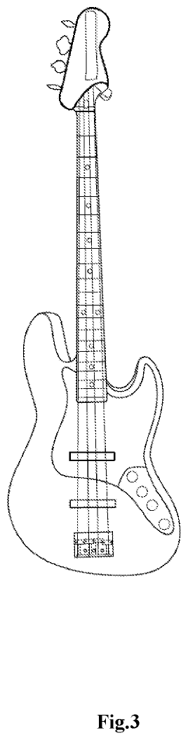

FIG. 4 discloses the perspective use and configuration of proposed assembly as per preferred embodiments of the invention.

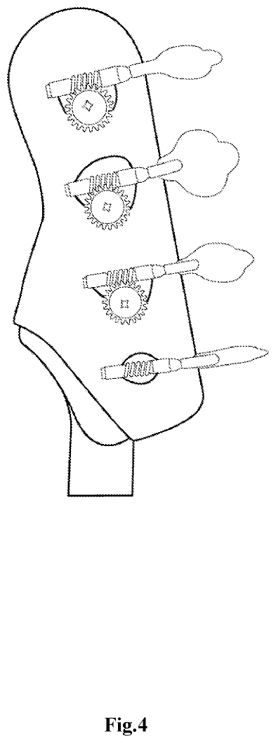

FIG. 5 discloses the back configuration of proposed assembly as per preferred embodiments of the invention.

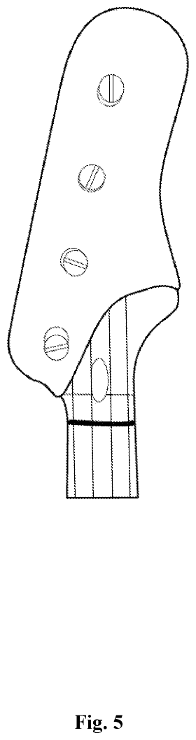

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced form of cover that fits over tuning pegs of guitar and provides effective coverage against wear and tear and provides personalized outlook to every guitar.

The body of the cover comprises an anterior region opposite a posterior region, and a central region located therebetween. The body tapers inward from a greater transverse width at anterior region to a smaller transverse width at central region forming first and second concave portions of central region, and terminating to a greater transverse width defining a pair of curved edge members at the posterior region.

The body of the cover is connected to a peripheral side member having an elasticized bottom edge adapted to allow the protective cover to form fit to the contours of the guitar body in an intimate, taut manner.

The body of the cover further comprises a fastener, clamp or clasp adapted to aid in securely holding the protective cover onto the guitar. When the protective cover is slipped operatively onto and protecting the tuning pegs, the fastener is designed, configured, and fastened such that the fastener is physically isolated from contact with the tuning pegs, thereby providing a guitar player with unobstructed access to and use of the control knobs and guitar strings during the playing of the guitar.

The use of the present invention provides personalized outlook and cover the wear and tear to the tuning pegs, while simultaneously allowing a guitar player with unobstructed access to and use of the control knobs, guitar strings, and the like during the playing of the instrument.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A tuning pegs cover comprising:
A fabric body;
A slip-on cover;
A back tie structure;
A zipper;
A clamp/clasp;
A Velcro; and;
Openings for tuning pegs for unobstructed playing of Guitar.

2: A tuning pegs cover which allows to form a protective cover to the tuning pegs and provides personalized outlook to every guitar owner. The cover is easy to install and remove and is low in cost and provides user the opportunity to change the outlook as often required.
